(19) United States
(12) Patent Application Publication
(10) Pub. No.: US 2025/0245649 A1
(43) Pub. Date: Jul. 31, 2025

(54) Segregated Funds Proxy and Token

(71) Applicant: Strands Technologies, Ltd., Road Town (VG)

(72) Inventors: Timothy G. Gorham, Charlotte, NC (US); Sean Russell Dawson, Sydney (AU); Henry Wu, San Juan (PR); Dominic Romanowski, Sydney (AU); Nicholas Forster, Sydney (AU); Justin Swanson, Chicago, IL (US); Kelly Settle, Chicago, IL (US); Ronald L. Wetzel, Chicago, IL (US); Cameron J. Baker, Sydney (AU)

(73) Assignee: Strands Technologies, Ltd., Road Town (VG)

(21) Appl. No.: 19/039,920

(22) Filed: Jan. 29, 2025

Related U.S. Application Data
(60) Provisional application No. 63/627,121, filed on Jan. 31, 2024.
(60) Provisional application No. 63/627,992, filed on Feb. 1, 2024.

(51) Int. Cl. G06Q 20/36

(52) U.S. Cl. CPC G06Q 20/3678; G06Q 2220/00

(57) ABSTRACT

A method for bridging real-world segregated fund accounts with on-chain representations includes receiving, at a meta-layer encoder, balance information from at least one segregated fund account in a physical-space; encoding, by the meta-layer encoder, the received balance information into a format compatible with a repository implemented on a blockchain; transmitting the encoded balance information to the repository; minting, by the repository, a meta-physical proxy (MPP) token to represent the segregated fund balance according to a blockchain token standard; and enabling interaction with the MPP token in a meta-space by one or more entities, wherein the meta-space comprises an environment for decentralized applications.

### CROSS-REFERENCE TO RELATED APPLICATIONS

The present disclosure claims priority to U.S. Provisional Patent Application No. 63/627,121, filed Jan. 31, 2024, and U.S. Provisional Patent Application No. 63/627,992, filed Feb. 1, 2024, the contents of each are incorporated by reference in their entirety.

### FIELD OF THE DISCLOSURE

The present disclosure relates generally to financial technology (Fintech). More particularly, the present disclosure relates to systems and methods for a segregated funds token and a segregated funds proxy.

### BACKGROUND OF THE DISCLOSURE

Segregated Fund accounts form the backbone of the current financial system. All funds held at U.S. brokerages must reside in a Segregated Fund account, providing customers with protection against a brokerage's potential bankruptcy and other legal risks. In the event such scenarios occur, investors—be they individuals or institutions—have a guarantee, backed by U.S. federal law, that their funds are held in segregated accounts and not commingled. This assurance is vital for maintaining confidence in U.S. financial markets and institutions.

The reserves in Segregated Funds are substantial. Among brokerages classified as Futures Commodities Merchants (FCMs), the amount held in segregated funds was nearly USD 350 billion as of October 2023. FCMs, which clear futures and options on futures trades, primarily serve professional institutions such as proprietary trading firms and hedge funds. More broadly, the four largest brokerage firms-Charles Schwab, Fidelity, TD, and E*—collectively held over USD 12.5 trillion across 90 million segregated fund accounts in 2013. While an accurate figure is difficult to determine, estimates suggest that, in that same year, the total amount held in segregated accounts reached nearly USD 30 trillion.

Segregated Funds, by nature, can be interest-bearing. By contrast, stablecoins face multiple issues at present. First, stablecoin users shoulder the risk of their registered provider, because fiat currency collateralizing these coins is commingled with the issuing company's own funds. If the issuing company faces bankruptcy, the stablecoin (and its holders) could also be exposed to losses. Segregated Funds do not carry this risk, offering significant certainty to major financial institutions. Second, stablecoins can introduce “bridge risk,” wherein funds can be hacked during bridge exploits. Finally, stablecoins typically offer no yield to holders—unlike Segregated Funds, which do pass on yield to their titled holders.

These drawbacks of stablecoins create friction in traditional markets, hindering the growth of Decentralized Finance (DeFi) and curtailing the sector's potential scope. True scaling of DeFi can only occur once these risks are adequately addressed.

### BRIEF SUMMARY OF THE DISCLOSURE

The present disclosure relates to systems and methods for a segregated funds token and a segregated funds proxy. In this disclosure, we introduce two concepts that illustrate how Segregated Fund information can be brought on-chain:

Segregated Funds Proxy (SFP): This is a form of information representing Segregated Fund Account values operating according to the ERC-20 standard. SFP serves as a Meta-Physical Proxy by forming a Meta-Physical Link between the traditional, physical space of Segregated Fund Accounts and the meta-space of smart contracts on the Ethereum network. It leverages the security and legal certainty of the traditional financial system while harnessing the programmability and global reach of Ethereum, thus offering critical enhancements to both traditional and decentralized finance.

Segregated Funds Tokens (SFTs): SFTs represent another use case within this system. Here, a link is formed to a custodian of tokens so that the amount of tokens held in a particular account, address, or logical structure can be proxied on-chain. By recording this data on a tamper-proof ledger, SFTs provide heightened transparency, streamlined oversight, and simpler compliance, creating powerful synergies between existing DeFi solutions and the legal safeguards inherent in Segregated Funds.

Together, SFP and SFT demonstrate the vast potential of bridging physical assets and on-chain infrastructures. By connecting these domains, they reduce operational risks, boost efficiency, and facilitate advanced financial services-laying the groundwork for robust, next-generation financial ecosystems.

### BRIEF DESCRIPTION OF THE DRAWINGS

The present disclosure is detailed through various drawings, where like components or steps are indicated by identical reference numbers for clarity and consistency.

FIG. 1 illustrates a system with a Meta-Physical Link (MPL) connecting Segregated Funds in the Physical-Space to decentralized applications in the Meta-Space.

FIG. 2 illustrates the system of FIG. 1 connecting the Physical-Space of Segregated Fund Accounts to the Meta-Space of Ethereum Virtual Machine (EVM)-based smart contracts.

FIG. 3 illustrates a flowchart of a process for bridging real-world segregated fund accounts with on-chain representations.

FIG. 4 illustrates a flowchart of a process for bridging custodial token data from a physical custodian to a decentralized blockchain.

FIG. 5 illustrates a flowchart of a process for facilitating secure, on-chain interactions for segregated fund accounts.

FIG. 6 illustrates a block diagram of a computing device, which may be used in the system of FIGS. 1 and 2 and for realizing the various processes described herein.

### DETAILED DESCRIPTION OF THE DISCLOSURE

The present disclosure includes a system that can create a reliable link between any disparate data source or infrastructure, enabling the trusted transfer of information via both traditional protocols (transmission control protocol (TCP)/user datagram protocol (UDP)) and widely adopted token standards (e.g., ERC-20, Ethereum Request for Comments 20). This novel approach revolves around using a token-based delivery mechanism, effectively passing key information-such as account balances-on public or private ledgers in a secure and interoperable manner. By incorporating web3 rails, the system offers a host of advantages, including universal integration with existing token platforms and an improved guarantee of information delivery.

This interoperability carries several critical benefits. First, it allows for the tokenization of information—for example, the balance of a Segregated Fund Account—in a secure manner that leverages the web3 ecosystem. Second, the system delivers universal integration by adhering to existing token standards, ensuring that nearly any platform or application already compatible with major tokens can seamlessly adopt it. Third, this consistent use of a common standard drives simplification of legacy systems; instead of building custom integration pipelines for each institution, the same method can be applied globally. Fourth, the system offers a guarantee of delivery, which is particularly significant for those seeking robust data transfer. Although comparable to UDP in speed, it surpasses UDP by incorporating an added layer of reliability—an aspect currently being explored in a dedicated paper. Finally, the system is explicitly designed for large institutions, providing them with enhanced safety, reliability, and user-friendly features that cater to high-stakes, enterprise-level needs.

The Segregated Funds Proxy (SFP) marks the a real-world implementation of this concept, focusing on Segregated Fund Accounts. It is the first system conceived and built to enable information from traditional financial structures—especially segregated fund accounts—to be harnessed in decentralized applications. This is achieved through a precise link and proxy mechanism that effectively bridges the gap between conventional financial institutions and blockchain-based systems.

The Segregated Funds Token (SFT) represents a second use case of the same underlying technology. In this instance, the tokenization framework can link to a custodian of tokens—such as digital assets or other on-chain holdings—and proxy the precise amount of tokens held in specific accounts, addresses, or logical structures. By blending the trust and security of traditional custodians with the transparency and programmability of blockchain, SFT provides another dimension of flexibility. Institutions, decentralized applications, and end-users alike can benefit from real-time, verifiable data regarding token custody and balances, further extending the reach and impact of this novel bridging mechanism.

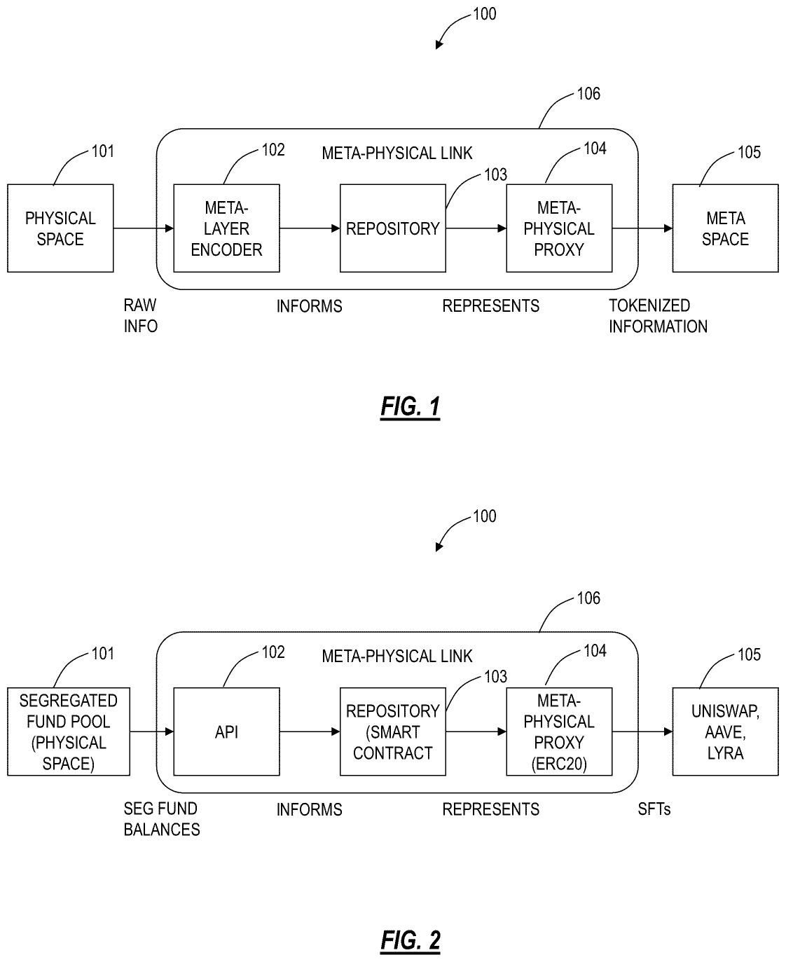

FIG. 1 illustrates a system 100 with a Meta-Physical Link (MPL) connecting Segregated Funds in the Physical-Space to decentralized applications in the Meta-Space. FIG. 2 illustrates the system 100 connecting the Physical-Space of Segregated Fund Accounts to the Meta-Space of Ethereum Virtual Machine (EVM)-based smart contracts. FIGS. 1 and 2 are a high-level illustration of the system 100's Meta-Layer architecture. As shown, the system 100 five primary components connected in sequence: Physical-Space 101, Meta-Layer Encoder 102, Repository 103, Meta-Physical Proxy (MPP) 104, and Meta-Space 105.

The system 100 illustrates how data and value flow between the Physical-Space 101, the Meta-Layer Encoder 102, the Repository 103, the Meta-Physical Proxy 104, and ultimately the Meta-Space 105. This progression forms the backbone of Strands' system, enabling real-world assets to be securely tokenized and utilized within on-chain ecosystems.

The system 100 includes Strands has built a Meta-Layer on top of traditional financial rails with the intention of enhancing all of finance. We posit that two distinct digital spaces must be connected to realize this potential revolution:
(1) The Physical-Space 101 includes traditional financial markets such as hedge funds, banks, brokers, and large institutions.
(2) The Meta-Space 105 encompasses smart contracts and decentralized applications that can run on Ethereum or any other blockchain with similar capabilities.

By bridging these two worlds, the system 100 allows information alone to flow freely—without introducing additional counterparty risk or friction—so that real-world financial data can be securely and programmatically used on-chain. This disclosure outlines the key definitions, architecture, and pilot program of a Meta-Physical Link (MPL) 106 connecting Segregated Funds in the Physical-Space 101 to decentralized applications in the Meta-Space 105.

The Physical-Space 101 refers to the traditional financial world—where hedge funds, banks, and institutions operate. We call it “physical” because it fundamentally relies on specialized hardware for ultra-low-latency trading and clearing of financial products (e.g., stocks, futures, options). The system 100 can interface with this realm using custom hardware, aligning traditional markets with advanced on-chain capabilities.

The Meta-Space 105 includes smart contracts and the ecosystems that run them. Examples include protocols like Uniswap, Aave, and Lyra. Smart contracts offer efficiency, accessibility, and cross-compatibility, making them powerful tools to disrupt existing financial and service-based industries. Notably, the definition of the Meta-Space 105 is blockchain-agnostic; any chain capable of running smart contracts can be integrated into the Meta-Layer.

To unite these two spaces, the system 100 introduces the concept of a Meta-Physical Link (MPL) 106. The MPL 106 establishes a secure bridge between the Physical-Space 101 and the Meta-Space 105, allowing information (e.g., account balances, ownership details) to flow between them. It includes multiple subsystems, each performing a specialized function in reading data from the Physical-Space 101, validating it, and then reflecting it in a format usable on-chain.

Two core subsystems of the MPL are:
(1) Meta-Layer Encoder 102: Reads relevant financial data from the Physical-Space 101 (e.g., Segregated Fund balances) through Application Programming Interfaces (APIs) or similar interfaces.
(2) Repository 103: A conduit—typically implemented as a smart contract—that translates incoming data from the Encoder 102 into on-chain representations. It also handles functions like minting, burning, and tracking balances of tokenized representations of real-world assets.

A Meta-Physical Proxy (MPP) 104 is the on-chain tokenized form of specific real-world information. For instance, ownership of funds in a Segregated Fund Account can be encapsulated as an MPP 104, allowing it to be used in the Meta-Space 105 just like any other token. It is important to note that the MPP 104 itself has no intrinsic value unless tied to the off-chain asset it represents-much like how TCP/UDP packets are simply carriers of information in traditional network systems.

The Segregated Funds Proxy (SFP) serves as a Meta-Physical Proxy 104 for balances in Segregated Fund Accounts. By constructing an MPL 106 between these accounts in the Physical-Space 101 and EVM-compatible smart contracts in the Meta-Space 105, SFPs allow real-world funds to be tokenized as ERC-20 tokens.

Tokenization of Segregated Funds: The MPL (Encoder 102+Repository 103) reads the latest balances from designated Segregated Fund Accounts, then mints or burns SFPs on-chain to reflect those balances.

Use Cases: Once minted, SFPs behave like standard ERC-20 tokens. Users and institutions can trade them on decentralized exchanges, use them as collateral, or integrate them into other on-chain applications.

Safety & Yield: Many Segregated Fund Accounts naturally accrue yield, enhancing the attractiveness of the underlying assets. Because the real-world fund remains securely held in a regulated environment, large institutions gain on-chain utility without surrendering the regulatory and legal assurances they require.

A separate yet related concept, the Segregated Funds Token (SFT) focuses on bridging custodial token data to the Meta-Space 105. This use case can proxy specific information—such as the number of tokens held in a certain account—by creating an MPP 104.

To interact directly with Segregated Fund balances on-chain, an entity must become a Primary Information Relayer (PIR). The process is as follows:
(1) KYC & Approval: A user or institution undergoes automated Know-Your-Customer (KYC) checks to ensure compliance.
(2) Mint & Burn Privileges: Once approved, the PIR can deposit funds into (or withdraw funds from) the Segregated Fund Account in the Physical-Space 101. The Encoder 102 recognizes these deposits/withdrawals and updates the Repository 103 accordingly. The PIR's address is then permitted to mint or burn SFPs to reflect the new Segregated Fund balance on-chain.
(3) Restrictive Access: Non-PIR addresses cannot directly redeem or mint SFPs for FIAT. They can, however, trade or transfer SFPs in the secondary Meta-Space 105 market.

A Pilot Program validated the core mechanics of SFP:
(1) Single PIR & Single Fund: Initially, there was one Segregated Fund Account, which naturally accrues yield, and one PIR with the power to mint and redeem SFPs.
(2) Minting Example: Suppose the PIR deposits X USD into the Segregated Fund Account, and the current value of 1 SFP is Y USD (e.g., Y=1.00). The Encoder 102 detects the X USD deposit and instructs the Repository (103) to mint X/Y SFPs to the PIR's designated on-chain wallet.
(3) Redeeming Example: If the PIR wishes to redeem Z SFPs, they send Z SFPs back to the Repository 103 for disposal and receive Z×Y USD from the Segregated Fund Account.
(4) Secondary Markets: While only the PIR can directly redeem SFPs for FIAT, secondary liquidity pools (e.g., SFP-to-stablecoin pairs on Uniswap) will allow other market participants to purchase or sell SFPs without redemption privileges. This design encourages a healthy secondary market and broadens DeFi participation.

As more PIRs and Segregated Fund Accounts are introduced, fungibility across SFPs from different sources will be addressed. The ultimate goal is to scale this pilot to multiple participants and accounts, thereby creating a robust bridge between conventional financial markets and the burgeoning DeFi ecosystem.

This represents a major milestone in connecting Physical-Space 101 assets—specifically Segregated Fund balances—to the Meta-Space 105 of smart contracts. Other options include
(1) Additional Asset Classes: Beyond Segregated Funds, other real-world assets (e.g., equities, bonds, commodities) can be tokenized via MPLs and brought on-chain.
(2) Advanced Compliance & Security: the system 100 can refine and expand automated KYC, AML, and security features to better serve large institutions and meet stringent regulatory demands.

Scalability & Performance: the Meta-Layer may incorporate custom hardware solutions for ultra-low-latency data feeds, bridging large-scale institutional needs with real-time on-chain interoperability.

Ecosystem Expansion: The introduction of safe, yield-bearing funds in DeFi has the potential to attract major traditional players—hedge funds, proprietary trading firms, family offices, and CTAs—who demand robust legal assurances. This new wave of capital could significantly advance DeFi's maturity and global adoption.

By establishing a Meta-Physical Link that enables Segregated Funds to be securely represented on-chain, the system provides a safe, efficient, and interoperable finance. Institutions that rely on segregated accounts for legal protections can now tap into DeFi's global liquidity and innovation without sacrificing their core requirements. In turn, the DeFi space gains access to deep, yield-bearing capital, fostering sustainable growth and broader adoption. With additional MPLs, the boundary between the Physical-Space 101 and the Meta-Space 105 will become increasingly permeable, heralding a new chapter in global financial markets.

The system 100 can be implemented through a combination of physical hardware, software services, and cloud-based resources to ensure scalability, security, and performance. In one example arrangement, the Physical-Space 101 interfaces with specialized, on-premises hardware for ultra-low-latency trading and data processing. Simultaneously, the Meta-Layer Encoder 102 can be deployed as containerized microservices hosted on cloud platforms (e.g., AWS, Azure, GCP) for flexible and resilient data ingest. The Repository 103 typically resides in one or more smart contracts on an EVM-compatible blockchain, orchestrated by secure middleware services that verify and route information flows. Meanwhile, the Meta-Physical Proxy 104 leverages cryptographic protocols to tokenize real-world financial data, and its interactions within the Meta-Space 105 are managed by blockchain nodes and decentralized applications. This layered approach allows system 100 to meet stringent institutional requirements for speed, reliability, and compliance, while harnessing the programmability and global reach of decentralized networks.

### Processes

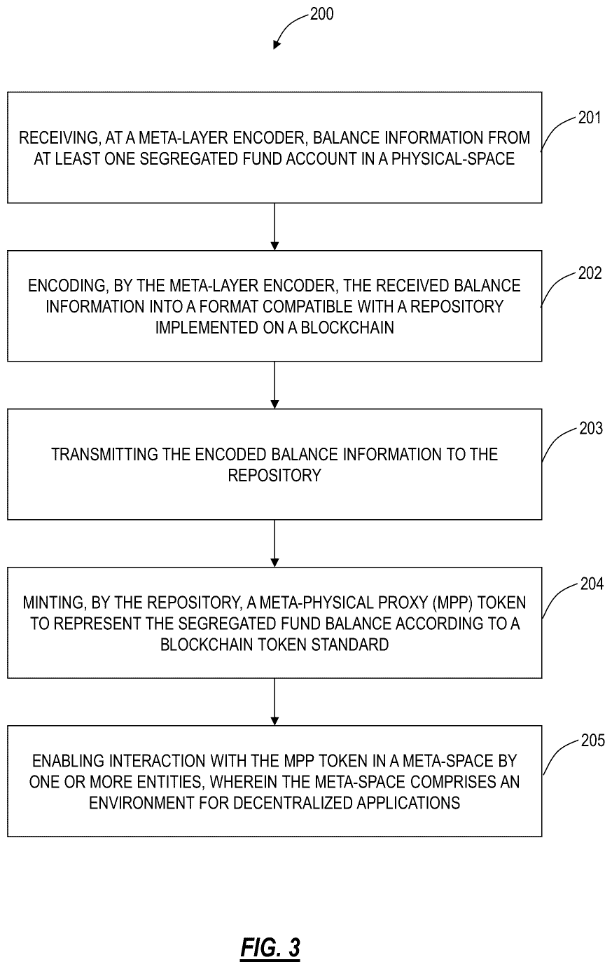

FIG. 3 illustrates a flowchart of a process 200 for bridging real-world segregated fund accounts with on-chain representations. The process 200 includes receiving, at a meta-layer encoder, balance information from at least one segregated fund account in a physical-space (step 201); encoding, by the meta-layer encoder, the received balance information into a format compatible with a repository implemented on a blockchain (step 202); transmitting the encoded balance information to the repository (step 203); minting, by the repository, a meta-physical proxy (MPP) token to represent the segregated fund balance according to a blockchain token standard (step 204); and enabling interaction with the MPP token in a meta-space by one or more entities, wherein the meta-space comprises an environment for decentralized applications (step 205).

The process 200 can further include validating, at the meta-layer encoder, the authenticity of the balance information using cryptographic or network-based verification prior to minting the MPP token. The process 200 can further include receiving, at the repository, a burn request for at least a portion of the MPP token; and adjusting the on-chain balance of the MPP token and updating the corresponding segregated fund account balance in the physical-space. The repository can be configured to distribute yield derived from the segregated fund account to holders of the MPP token based on proportional on-chain balances, and wherein the yield distribution is executed by one or more smart contracts in the repository.

The process 200 can further include querying, from the meta-layer encoder, a custodial service in the physical-space for a token balance associated with a particular account or address; packaging the token balance into a data structure that conforms to the blockchain token standard; and creating, by the repository, a separate MPP token on-chain representing the custodial token balance, thereby allowing on-chain interactions in the meta-space. The MPP token created for the custodial token balance can be implemented as an ERC-20 token and includes metadata linking the ERC-20 token to the underlying balance in the physical-space.

The process 200 can further include verifying, by an automated Know-Your-Customer (KYC) process, whether a user seeking to mint or burn the MPP token is a primary information relayer (PIR); permitting only addresses passing the KYC process to execute mint or burn operations; and allowing secondary market participants to trade the MPP token in the meta-space without granting them direct privileges to mint or burn. The process 200 can further include establishing a yield-bearing mechanism for the segregated fund account in the physical-space and distributing any accrued yield to MPP token holders in the meta-space based on a pro-rata allocation captured by smart contract event logs.

The process 200 can further include implementing a pilot program to validate the on-chain representation of segregated fund balances, wherein the pilot program: designates a single PIR and a single segregated fund account; enables the PIR to deposit funds into the segregated fund account and to mint a corresponding quantity of MPP tokens; and allows the PIR to redeem the MPP tokens for an equivalent amount of fiat currency from the segregated fund account. The process 200 can further include expanding the pilot program to multiple PIRs and multiple segregated fund accounts; addressing fungibility requirements across MPP tokens issued from different segregated fund accounts; and integrating enhanced compliance checks, including AML reviews and multi-jurisdictional regulatory approvals.

The process 200 can further include scaling the tokenization process to additional asset classes by: deploying the meta-layer encoder to retrieve balances of equities, bonds, or commodities in the physical-space; generating corresponding MPP tokens for each asset class on the blockchain via the repository; and enabling atomic swaps or collateralization of these MPP tokens within the meta-space. The process 200 can further include integrating an automated compliance engine for each additional asset class, wherein the compliance engine verifies ownership limits, regulatory permissions, or regional mandates prior to minting or transferring the respective MPP tokens.

The process 200 can further include ensuring security of on-chain representations of segregated fund accounts by: employing cryptographic signatures or zero-knowledge proofs to confirm balances in the physical-space; restricting interactions with the repository to addresses that pass identity-based KYC/AML checks; continuously monitoring for bridge exploits or suspicious transactions; and triggering an emergency shutdown or freeze function in the repository if specified security thresholds are exceeded. The meta-layer encoder can be implemented as containerized microservices hosted on a cloud platform, and the repository resides on one or more smart contracts in an EVM-compatible blockchain environment.

The process 200 can further include detecting yield accrual events in the segregated fund account; storing yield-related updates in the repository; allocating the yield to MPP token holders according to their on-chain balances; generating an on-chain event to track the yield distribution; and providing a dashboard or user interface for real-time monitoring of balances, transaction histories, and yield distributions.

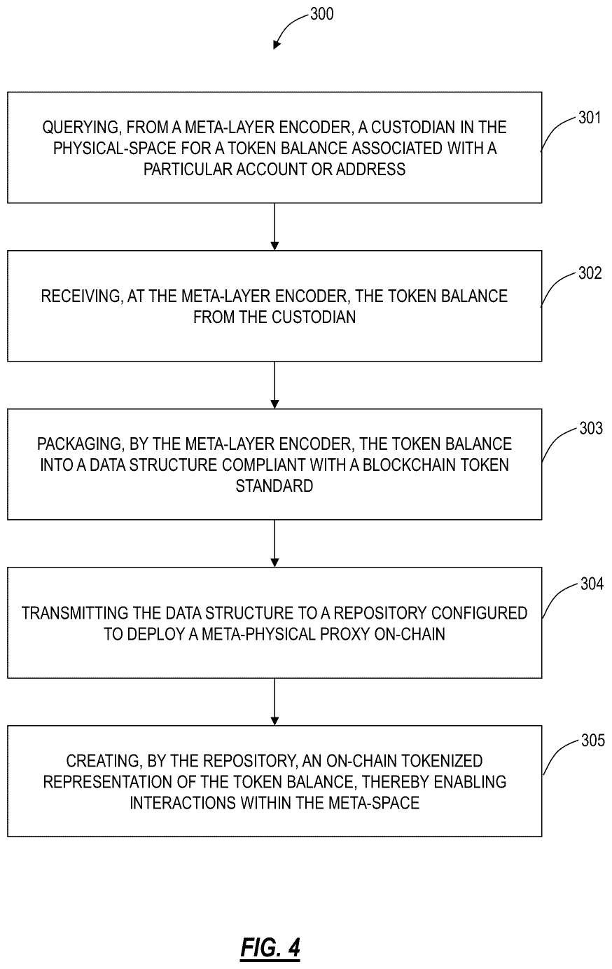

FIG. 4 illustrates a flowchart of a process 300 for bridging custodial token data from a physical custodian to a decentralized blockchain. The process 300 includes querying, from a meta-layer encoder, a custodian in the physical-space for a token balance associated with a particular account or address (step 301); receiving, at the meta-layer encoder, the token balance from the custodian (step 302); packaging, by the meta-layer encoder, the token balance into a data structure compliant with a blockchain token standard (step 303); transmitting the data structure to a repository configured to deploy a meta-physical proxy on-chain (step 304); and creating, by the repository, an on-chain tokenized representation of the token balance, thereby enabling interactions within the meta-space (step 305).

The on-chain tokenized representation can be embodied as an ERC-20 token and the process 300 can further include metadata linking the ERC-20 token to the underlying custodian balance in the physical-space; and functionality allowing authorized entities to reconcile or update the tokenized balance based on changes in the custodial account.

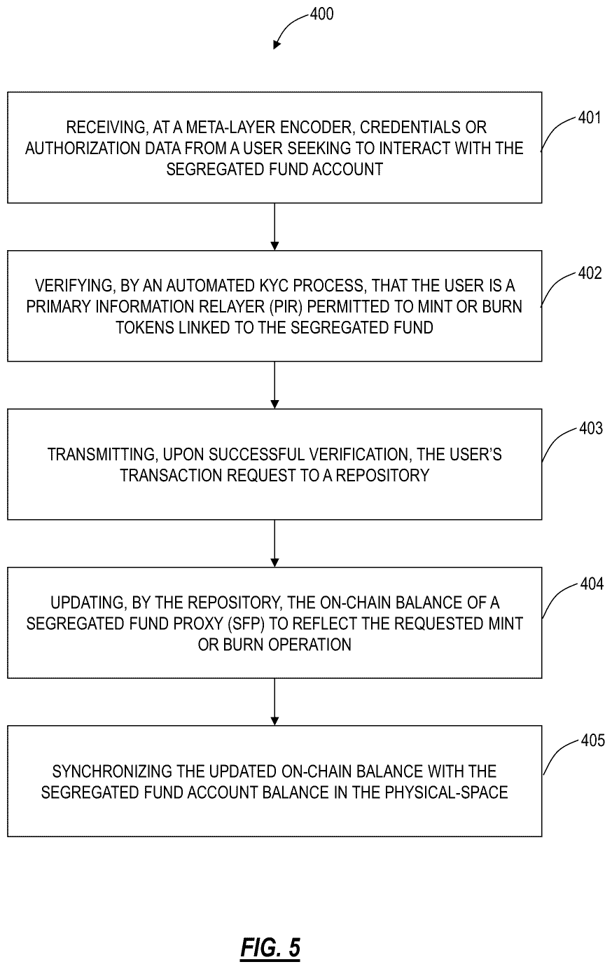

FIG. 5 illustrates a flowchart of a process 400 for facilitating secure, on-chain interactions for segregated fund accounts. The process 400 includes receiving, at a meta-layer encoder, credentials or authorization data from a user seeking to interact with the segregated fund account (step 401); verifying, by an automated KYC process, that the user is a primary information relayer (PIR) permitted to mint or burn tokens linked to the segregated fund (step 402); transmitting, upon successful verification, the user's transaction request to a repository (step 403); updating, by the repository, the on-chain balance of a segregated fund proxy (SFP) to reflect the requested mint or burn operation (step 404); and synchronizing the updated on-chain balance with the segregated fund account balance in the physical-space (step 405).

The process 400 can further include restricting, in the repository, mint and burn privileges to addresses that pass an identity-based KYC/AML check; and permitting secondary market participants to trade the SFP on decentralized exchanges within the meta-space without granting them direct mint or burn privileges. The process 400 can further include establishing a yield-bearing mechanism within the segregated fund account in the physical-space; distributing, by the repository, accrued yield to SFP holders in the meta-space according to their pro-rata ownership; and reflecting the yield distribution on-chain through an event log emitted by the repository.

Various other approaches are also contemplated, such as a process or scaling tokenized representations of segregated fund accounts to additional asset classes which includes deploying a meta-physical link for reading balances of new asset classes within the physical-space; generating meta-physical proxies for each asset class in the repository, each meta-physical proxy conforming to a specified token standard; enabling atomic swaps or collateralization of these newly tokenized assets within the meta-space; and maintaining ongoing synchronization between the physical-space and the meta-space for real-time compliance and auditing.

Also, a process for ensuring security of on-chain segregated fund representations includes employing cryptographic signatures or zero-knowledge proofs to confirm balances in the physical-space before any mint or burn operation in the repository; restricting interactions with the repository to addresses that pass an identity-based KYC/AML check; continuously monitoring for bridge exploits or anomalous transaction behaviors in the meta-space; triggering an emergency shutdown or freeze function in the repository if predetermined security thresholds are exceeded; and logging security events and attempted breaches for subsequent auditing and compliance analysis.

Further a process for distributing yield and providing transparent reporting for on-chain representations of segregated funds includes detecting yield accrual events in the segregated fund account; updating, via the meta-layer encoder, a yield-tracking variable in the repository; proportionally allocating the detected yield to all SFP holders in the meta-space according to their on-chain balances; issuing an on-chain event that details the yield distribution, including amounts allocated and the specific addresses receiving them; and providing a user interface or dashboard that aggregates and displays real-time balances, transaction histories, and yield distributions, thereby simplifying compliance and reporting procedures.

The various processes can be implemented in various ways, including: as a method including steps, via circuitry (specialized hardware and/or general-purpose hardware configured to execute those steps), and through a non-transitory computer-readable medium that stores instructions which, when executed, cause one or more processors to perform the steps. This flexibility ensures the processes can be adapted to different system architectures and deployment scenarios.

### Computing Device

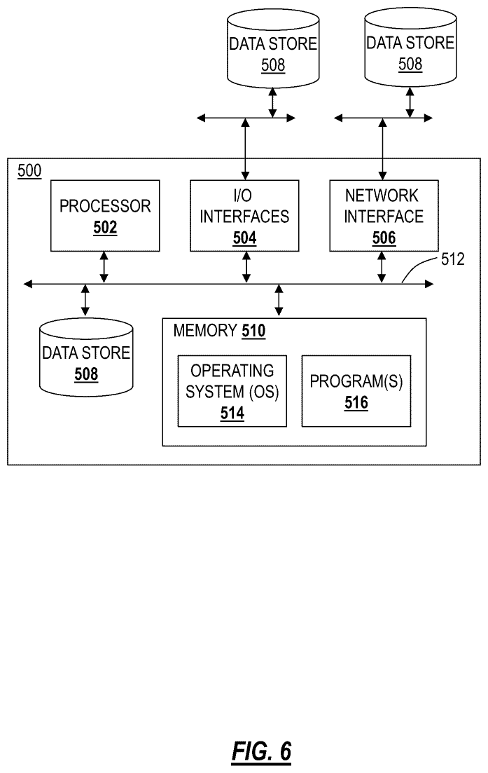

FIG. 6 illustrates a block diagram of a computing device 500, which may be used in the system 100 and for realizing the various processes described herein. The computing device 500 may be a digital computer that, in terms of hardware architecture, generally includes a processor 502, input/output (I/O) interfaces 504, a network interface 506, a data store 508, and memory 510. It should be appreciated by those of ordinary skill in the art that FIG. 6 depicts the computing device 500 in an oversimplified manner, and a practical embodiment may include additional components and suitably configured processing logic to support known or conventional operating features that are not described in detail herein. The components (502, 504, 506, 508, and 510) are communicatively coupled via a local interface 512. The local interface 512 may be, for example, but not limited to, one or more buses or other wired or wireless connections, as is known in the art. The local interface 512 may have additional elements, which are omitted for simplicity, such as controllers, buffers (caches), drivers, repeaters, and receivers, among many others, to enable communications. Further, the local interface 512 may include address, control, and/or data connections to enable appropriate communications among the aforementioned components.

The processor 502 is a hardware device for executing software instructions. The processor 502 may be any custom made or commercially available processor, a Central Processing Unit (CPU), an auxiliary processor among several processors associated with the computing device 500, a semiconductor-based microprocessor (in the form of a microchip or chipset), or generally any device for executing software instructions. When the computing device 500 is in operation, the processor 502 is configured to execute software stored within the memory 510, to communicate data to and from the memory 510, and to generally control operations of the computing device 500 pursuant to the software instructions. The I/O interfaces 504 may be used to receive user input from and/or for providing system output to one or more devices or components.

The network interface 506 may be used to enable the computing device 500 to communicate on a network. The network interface 506 may include, for example, an Ethernet card or adapter or a Wireless Local Area Network (WLAN) card or adapter. The network interface 506 may include address, control, and/or data connections to enable appropriate communications on the network. A data store 508 may be used to store data. The data store 508 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data store 508 may incorporate electronic, magnetic, optical, and/or other types of storage media. In one example, the data store 508 may be located internal to the computing device 500, such as, for example, an internal hard drive connected to the local interface 512 in the computing device 500. Additionally, in another embodiment, the data store 508 may be located external to the computing device 500 such as, for example, an external hard drive connected to the I/O interfaces 504 (e.g., SCSI or USB connection). In a further embodiment, the data store 508 may be connected to the computing device 500 through a network, such as, for example, a network-attached file server.

The memory 510 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 510 may incorporate electronic, magnetic, optical, and/or other types of storage media. Note that the memory 510 may have a distributed architecture, where various components are situated remotely from one another but can be accessed by the processor 502. The software in memory 510 may include one or more software programs, each of which includes an ordered listing of executable instructions for implementing logical functions. The software in the memory 510 includes a suitable Operating System (O/S) 514 and one or more programs 516. The operating system 514 essentially controls the execution of other computer programs, such as the one or more programs 516, and provides scheduling, input-output control, file and data management, memory management, and communication control and related services. The one or more programs 516 may be configured to implement the various processes, algorithms, methods, techniques, etc. described herein.

Those skilled in the art will appreciate that the system 100 and the various processes can be implemented via one or more computing devices 500. Further, multiple computing devices 500 can form a cloud. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase SaaS is sometimes used to describe application programs offered through cloud computing. A common shorthand for a provided cloud computing service (or even an aggregation of all existing cloud services) is “the cloud.”

### Meta-Physical Link (MPL)

The MPL is a generalized mechanism for bringing real-world data—or any information from a disparate, off-chain system—onto a blockchain in a secure, reliable, and interoperable manner. While much of the example focuses on Segregated Fund Accounts and their proxy tokens (SFP and SFT), the MPL itself is intended to be chain-agnostic and can be extended to virtually any type of data or asset.

The Meta-Physical Link (MPL) is a bridging architecture that securely translates data from traditional or off-chain systems (“Physical Space”) into on-chain representations (“Meta-Space”). Once on-chain, this data can be used by decentralized applications (DApps), smart contracts, and other blockchain-based services. Again, the Physical Space include traditional environments such as banks, brokerages, custodians, or any data source. Interfaces can be proprietary APIs, FIX/FAST feed protocols, or standard web service calls over TCP/UDP, among others. Data is often sensitive, regulated, and requires robust authentication and authorization. The Meta-Space is the on-chain environment, typically a smart-contract-capable blockchain (e.g., Ethereum, an EVM-compatible chain, or another Layer 1/Layer 2). Data and tokens in this space follow widely-used token standards (e.g., ERC-20, ERC-721).

The Meta-Layer is a combination of software, middleware, and/or hardware (collectively referred to as “Encoder” and “Repository” in the disclosure) that performs the translation and synchronization between off-chain and on-chain environments. The MPL is the set of protocols, message structures, and security features that bind these components into a single reliable flow of information.

### Meta-Layer Encoder

Data Ingestion: Connects to off-chain sources (bank APIs, broker data feeds, custodian updates, etc.). Can support RESTful APIs, FIX protocols, custom feeds, or direct database queries.

Data Validation: Ensures authenticity and accuracy of incoming data. May perform cryptographic checks (e.g., digital signatures, TLS/SSL, PGP) or rely on hardware security modules (HSMs).

Transformation & Encoding: Takes raw off-chain data (e.g., an account balance in a segregated account, an equity position, or a custodian token balance) and encodes it into a standardized data structure (often JSON, Protobuf, or domain-specific structure). Applies business logic to determine if a mint, burn, or other state change is required in the on-chain environment.

Queueing & Reliability: Manages a queuing system to handle bursts of incoming data. Incorporates reliability strategies that go beyond simple UDP-based transport, ensuring messages that pass validation are not dropped or lost before reaching the chain. Uses retry logic, commit logs, or message brokers (e.g., Kafka, RabbitMQ) to ensure robust delivery.

### Repository (On-Chain Component)

Smart Contract(s): Implements the logic to reflect real-world data as on-chain tokens or data records. Typically follows a standard such as ERC-20 (for fungible balances) or ERC-721/ERC-1155 (for non-fungible/collectible data).

Mint & Burn Mechanisms: Dynamically adjusts token supplies based on verified updates from the Meta-Layer Encoder. Enforces strict role-based access control: only whitelisted or KYC-verified addresses (Primary Information Relayers, or PIRs) can call mint/burn functions.

On-Chain State Tracking: Maintains real-time or near-real-time reflection of the off-chain asset or data. Can store additional metadata (e.g., “token is pegged to a Segregated Fund Account #XXXX at Broker Y”).

Event Logging: Every mint, burn, or balance update is emitted as an on-chain event. Provides transparent, immutable audit trails for regulators, compliance officers, and end-users.

### Meta-Physical Proxy (MPP) Tokens

An MPP token is the on-chain representation of some off-chain data. In the examples given:

Segregated Funds Proxy (SFP): represents ownership in a Segregated Fund Account.

Segregated Funds Token (SFT): represents token balances held by a custodian in a designated account.

The core idea is that any off-chain data (e.g., a user's deposit in a bank account, a physical gold holding, a real estate deed) can be mapped to a unique token on-chain. Generally an ERC-20 for fungible claims (e.g., stable monetary balances, shares in a fund). Could be ERC-721 or a specialized standard for non-fungible items or more complex data structures.

Lifecycle: Mint: Occurs when new off-chain assets are deposited or recognized by the system. Burn: Occurs when off-chain assets are redeemed, withdrawn, or otherwise invalidated. Transfer: The MPP token can be freely transferred among on-chain participants, subject to compliance logic (if applicable).

### Key Processes and Data Flows

Data Retrieval & Verification. This process begins with an event in the Physical-Space, such as a deposit or withdrawal in a Segregated Fund Account, or a custodian's update to a user's token balance in an internal ledger. The Meta-Layer Encoder then periodically queries the account or receives push notifications to detect these changes, verifying the authenticity of the incoming data through cryptographic signatures, secure channels, or both. Once verified, the Encoder places the update (for instance, “Account #1234 balance changed from 1 M USD to 1.2 M USD”) into a secure queue, ensuring reliable transmission to the on-chain environment.

On-Chain Synchronization. In the next step, the Meta-Layer Encoder assembles an on-chain transaction or set of calls to the Repository's smart contract(s), including details such as “Mint 200,000 new SFP tokens to reflect the new deposit.” When this transaction is received, the Repository checks if the calling address is authorized (i.e., a Primary Information Relayer, or PIR). If valid, the contract updates the on-chain state accordingly.

To maintain transparency and auditability, it then emits an event (e.g., Mint(address indexed to, uint256 value)) that can be tracked by blockchain explorers, compliance dashboards, or aggregator services.

Redemption & Synchronization. The redemption process begins when a PIR (or a user authorized by the PIR) initiates a “burn” transaction to exchange tokens for actual off-chain assets. The Repository contract reduces the MPP token balance in the user's on-chain address and emits a corresponding “burn” event. In parallel—either through an automated flow or a separate procedure—the user's real-world account in the Physical-Space is credited or debited for the appropriate amount, completing the redemption cycle.

### Security and Compliance Considerations

KYC/AML Enforcement. Only addresses designated as Primary Information Relayers (PIRs) can invoke mint or burn functions. PIRs must pass rigorous Know-Your-Customer (KYC), Anti-Money Laundering (AML), and, if applicable, “accredited investor” checks to ensure regulatory compliance. While other market participants are free to trade or hold MPP tokens on-chain, they cannot redeem these tokens for off-chain assets, thereby maintaining a clear compliance boundary.

Reliability Against Bridge Exploits. The MPL is not a traditional cross-chain bridge. Segregated accounts remain regulated and off-chain, and the bridging protocol never takes custody of those funds. Because only off-chain data is being mirrored on-chain (as opposed to physically locking assets in a smart contract), the risk of hacking or exploits is significantly lower. Furthermore, data integrity is strengthened via cryptographic signatures from custodians or brokers, and the system can employ an emergency freeze or kill switch in the Repository if anomalies—such as suspiciously large mint requests—are detected.

Auditable, Immutable History. Every token mint or burn transaction triggers a verifiable on-chain event, enabling regulators and market participants to trace the complete history of token supply and transfers. Off-chain reconciliation processes ensure that any tokens created or destroyed on-chain accurately match real-world deposits and withdrawals, closing the loop between Physical-Space and Meta-Space transactions.

### MPL Use Cases Beyond Segregated Funds

One prominent use case involves tokenizing equities, bonds, or commodities, where MPL can retrieve share balances from brokerage accounts or positions in a clearinghouse and mint “equity proxy tokens” on-chain. This enables on-chain composability, allowing traditionally siloed assets (e.g., equity shares) to serve as collateral in various DeFi protocols. In real estate or precious metals, MPL can represent property titles, real estate deeds, or gold bars stored in vaults as on-chain tokens, facilitating fractional ownership, streamlined secondary market trading, and simplified cross-border settlements.

The MPL also supports a custodial token link for crypto custodians holding large amounts of client assets in cold storage. Here, the MPL can reflect aggregated or account-specific balances on-chain, with near-real-time updates whenever custody conditions change. Finally, regulated digital assets benefit from the MPL's ability to enforce licensing checks, region-based restrictions, or advanced compliance logic, appealing to large institutional players that require strong legal frameworks and oversight.

### Technical Implementation Outline

Encoder Deployment. The Encoder can run as containerized microservices-using Docker or Kubernetes-on secure cloud platforms (e.g., AWS, Azure, GCP) or in on-premises environments that demand ultra-low-latency trading. It may integrate message brokers such as Kafka or RabbitMQ for queuing validated data and utilize a hardware security module (HSM) or similar secure signing tool for on-chain authentication.

On-Chain Repository. Deployed as a set of Solidity contracts for EVM-based chains (or equivalent contracts on other blockchain platforms), the Repository includes critical features such as role-based access for mint/burn operations, data structures referencing off-chain accounts or assets, logic for yield distribution (if the assets generate yield), and upgrade patterns (like proxy contracts) to accommodate future enhancements or regulatory changes.

MPP Token Standard. Typically derived from OpenZeppelin's ERC-20 or ERC-721 libraries, these tokens include metadata linking them to the off-chain data source, such as a broker ID or account number. Optional compliance modules—like whitelisting addresses or toggling transfer restrictions—can be added to meet regulatory requirements.

Security Layers. Communications between the Physical-Space servers and the Encoder are secured via TLS or VPN tunnels, and the Repository strictly whitelists PIR addresses. Automated anomaly detection or rate-limiting mechanisms further mitigate the risk of rapid, unintended mint/burn cycles that could threaten system integrity.

### Performance, Scalability, and Future Directions

Performance Requirements. In high-frequency trading environments, institutions may require sub-millisecond synchronization, yet for many asset classes—where an end-of-day net asset value suffices—minute- or hour-level updates are typically acceptable. MPL parameters can be tuned to align with the asset class or institution's performance needs.

Scaling to Multiple Assets and Institutions. The MPL architecture is designed for reuse across various asset classes, accounts, and brokers, with the Encoder configured to handle new data sources. Each asset class can map to its own on-chain token or be aggregated into broader fungible classes depending on the requirements.

Yield Distribution. If the off-chain asset naturally accrues interest (e.g., Segregated Fund Accounts), the MPL updates the on-chain total supply to reflect yield growth. Smart contracts then distribute the yield proportionally to all token holders, replicating an interest-bearing token model.

Extended Compliance. Future versions may employ chain analytics to flag and respond to suspicious transactions, and enforce region-specific rules such as automatic freezes on tokens that trigger regulatory alerts.

Hardware Acceleration. In scenarios requiring high throughput, specialized hardware (such as FPGA-based data capture and co-located servers in major financial hubs) can feed the MPL with extremely low latency, bridging real-world data to the Meta-Space in near real-time.

The Meta-Physical Link (MPL) provides a universal, token-based mechanism for securely bringing real-world data onto blockchains. By combining robust data ingestion, cryptographic verification, and standardized on-chain repositories, MPL ensures minimal counterparty or “bridge” risk, seamless compatibility with existing DeFi protocols, and a built-in compliance structure for mint/burn operations. Its reusable architecture supports a diverse range of asset classes—including segregated funds, equities, real estate, and commodities—and its immutable audit logs enhance transparency and reporting. By merging traditional legal safeguards with the programmability of decentralized networks, MPL unlocks next-generation financial services and significantly broadens the scope of on-chain innovation.

### Processing Circuitry and Non-Transitory Computer-Readable Mediums

Those skilled in the art will recognize that the various embodiments may include processing circuitry of various types. The processing circuitry might include, but are not limited to, general-purpose microprocessors; central processing units (CPUs); digital signal processors (DSPs); specialized processors such as network processors (NPs) or network processing units (NPUs), graphical processing units (GPUs); field programmable gate arrays (FPGAs); programmable logic device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more application-specific integrated circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, read-only memory (ROM), programmable read-only memory (PROM), erasable programmable read-only memory (EPROM), electrically erasable programmable read-only memory (EEPROM), flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### CONCLUSION

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner-whether collectively, in subsets, or individually-thereby broadening the range of potential embodiments.

What is claimed is:

1. A method for bridging real-world segregated fund accounts with on-chain representations, the method comprising:
receiving, at a meta-layer encoder, balance information from at least one segregated fund account in a physical-space;
encoding, by the meta-layer encoder, the received balance information into a format compatible with a repository implemented on a blockchain;
transmitting the encoded balance information to the repository;
minting, by the repository, a meta-physical proxy (MPP) token to represent the segregated fund balance according to a blockchain token standard; and
enabling interaction with the MPP token in a meta-space by one or more entities, wherein the meta-space comprises an environment for decentralized applications.

2. The method of claim 1, further comprising validating, at the meta-layer encoder, authenticity of the balance information using cryptographic or network-based verification prior to minting the MPP token.

3. The method of claim 1, further comprising:
receiving, at the repository, a burn request for at least a portion of the MPP token; and
adjusting the on-chain balance of the MPP token and updating a corresponding segregated fund account balance in the physical-space.

4. The method of claim 1, wherein the repository is configured to distribute yield derived from the segregated fund account to holders of the MPP token based on proportional on-chain balances, and wherein the yield distribution is executed by one or more smart contracts in the repository.

5. The method of claim 1, further comprising:
querying, from the meta-layer encoder, a custodial service in the physical-space for a token balance associated with a particular account or address;
packaging the token balance into a data structure that conforms to the blockchain token standard; and
creating, by the repository, a separate MPP token on-chain representing the custodial token balance, thereby allowing on-chain interactions in the meta-space.

6. The method of claim 5, wherein the MPP token created for the custodial token balance is implemented as an ERC-20 token and includes metadata linking the ERC-20 token to an underlying balance in the physical-space.

7. The method of claim 1, further comprising:
verifying, by an automated KYC process, whether a user seeking to mint or burn the MPP token is a primary information relayer (PIR);
permitting only addresses passing the KYC process to execute mint or burn operations; and
allowing secondary market participants to trade the MPP token in the meta-space without granting them direct privileges to mint or burn.

8. The method of claim 1, further comprising establishing a yield-bearing mechanism for the segregated fund account in the physical-space and distributing any accrued yield to MPP token holders in the meta-space based on a pro-rata allocation captured by smart contract event logs.

9. The method of claim 1, further comprising implementing a pilot program to validate the on-chain representation of segregated fund balances, wherein the pilot program:
designates a single PIR and a single segregated fund account;
enables the PIR to deposit funds into the segregated fund account and to mint a corresponding quantity of MPP tokens; and
allows the PIR to redeem the MPP tokens for an equivalent amount of fiat currency from the segregated fund account.

10. The method of claim 9, further comprising:
expanding the pilot program to multiple PIRs and multiple segregated fund accounts;
addressing fungibility requirements across MPP tokens issued from different segregated fund accounts; and
integrating enhanced compliance checks, including AML reviews and multi-jurisdictional regulatory approvals.

11. The method of claim 1, further comprising scaling a tokenization process to additional asset classes by:
deploying the meta-layer encoder to retrieve balances of equities, bonds, or commodities in the physical-space;
generating corresponding MPP tokens for each asset class on the blockchain via the repository; and
enabling atomic swaps or collateralization of these MPP tokens within the meta-space.

12. The method of claim 11, further comprising integrating an automated compliance engine for each additional asset class, wherein the compliance engine verifies ownership limits, regulatory permissions, or regional mandates prior to minting or transferring the respective MPP tokens.

13. The method of claim 1, further comprising ensuring security of on-chain representations of segregated fund accounts by:
employing cryptographic signatures or zero-knowledge proofs to confirm balances in the physical-space;
restricting interactions with the repository to addresses that pass identity-based KYC/AML checks;
continuously monitoring for bridge exploits or suspicious transactions; and
triggering an emergency shutdown or freeze function in the repository if specified security thresholds are exceeded.

14. The method of claim 1, wherein the meta-layer encoder is implemented as containerized microservices hosted on a cloud platform, and the repository resides on one or more smart contracts in an EVM-compatible blockchain environment.

15. The method of claim 1, further comprising:
detecting yield accrual events in the segregated fund account;
storing yield-related updates in the repository;
allocating the yield to MPP token holders according to their on-chain balances;
generating an on-chain event to track yield distribution; and
providing a dashboard or user interface for real-time monitoring of balances, transaction histories, and yield distributions.

16. A method for bridging custodial token data from a physical custodian to a decentralized blockchain, the method comprising:
querying, from a meta-layer encoder, a custodian in a physical-space for a token balance associated with a particular account or address;
receiving, at the meta-layer encoder, the token balance from the custodian;
packaging, by the meta-layer encoder, the token balance into a data structure compliant with a blockchain token standard;
transmitting the data structure to a repository configured to deploy a meta-physical proxy on-chain; and
creating, by the repository, an on-chain tokenized representation of the token balance, thereby enabling interactions within a meta-space.

17. The method of claim 15, wherein the on-chain tokenized representation is embodied as an ERC-20 token and further comprises:
metadata linking the ERC-20 token to an underlying custodian balance in the physical-space; and
functionality allowing authorized entities to reconcile or update the tokenized balance based on changes in a custodial account.

18. A method for facilitating secure, on-chain interactions for segregated fund accounts, the method comprising:
receiving, at a meta-layer encoder, credentials or authorization data from a user seeking to interact with the segregated fund account;
verifying, by an automated KYC process, that the user is a primary information relayer (PIR) permitted to mint or burn tokens linked to the segregated fund;
transmitting, upon successful verification, a user's transaction request to a repository;
updating, by the repository, an on-chain balance of a segregated fund proxy (SFP) to reflect a requested mint or burn operation; and
synchronizing the updated on-chain balance with the segregated fund account balance in a physical-space.

19. The method of claim 18, further comprising:
restricting, in the repository, mint and burn privileges to addresses that pass an identity-based KYC/AML check; and
permitting secondary market participants to trade the SFP on decentralized exchanges within a meta-space without granting them direct mint or burn privileges.

20. The method of claim 18, further comprising:
establishing a yield-bearing mechanism within the segregated fund account in the physical-space;
distributing, by the repository, accrued yield to SFP holders in a meta-space according to their pro-rata ownership; and
reflecting the yield distribution on-chain through an event log emitted by the repository.
